(19) United States
(12) Patent Application Publication
(10) Pub. No.: US 2012/0058362 A1
(43) Pub. Date: Mar. 8, 2012

(54) METHOD FOR DEPOSITING METAL ON A SUBSTRATE; METAL STRUCTURE AND METHOD FOR PLATING A METAL ON A SUBSTRATE

(75) Inventors: Markus Zistler, Regensburg (DE); Stephan Bradl, Regensburg (DE)

(73) Assignee: INFINEON TECHNOLOGIES AG, Neubiberg (DE)

(21) Appl. No.: 12/877,118

(22) Filed: Sep. 8, 2010

(51) Int. Cl. B32B 15/01; B05D 3/10

(52) U.S. Cl. 428/637; 427/301; 427/305

(57) ABSTRACT

Various embodiments provide a method for depositing metal on a substrate. The method may include carrying out a first immersion plating process, thereby forming a first metal portion on the substrate; providing an immersion plating activating substance on the first metal portion; and carrying out a second immersion plating process using the immersion plating activating substance, thereby forming a second metal portion on the first metal portion.

### TECHNICAL FIELD

Various embodiments relate generally to a method for depositing metal on a substrate; a metal structure and a method for plating a metal on a substrate.

### BACKGROUND

In order to deposit a metal layer on a substrate using a plating process, there are usually two conventional possibilities: the galvanic metal deposition (also referred to as electroplating), and the electroless/chemical metal deposition (also referred to as electroless/chemical plating).

In the galvanic metal deposition, impressing an electrical current or an electrical voltage to a substrate to be plated drives the deposition of the metal(s) being soluted in a plating electrolyte.

The electroless/chemical plating may be divided into two subgroups:

The so-called autocatalytic plating process: In this case, the driving force of the process is the reduction of the metal being soluted in the electrolyte by means of a reducing agent being soluted in the electrolyte.

The so-called immersion plating process: In this case, the driving force of the process is the electrochemical series. In this case, the metal having a higher degree of nobility, which is soluted in the electrolyte, is deposited on a metal having a lower degree of nobility during an electrochemical exchange reaction.

In order to deposit a metal layer (e.g. Au) having a large thickness on a substrate, the substrate is conventionally immersed into an electrolyte, which contains Au in a complex form (e.g. cyanidic or sulfidic) as well as a reducing agent. The driving force of this process is the autocatalytic reaction of the reducing agent, by means of which the Au contained in the electrolyte is reduced. This process achieves a high Au layer thickness. However, this process usually only shows a very low process stability and a difficult and complex process control. One problem in this process may be seen in the very low bath stability of the bath containing the electrolyte, due to the autocatalytic process. This has the result that the lifetime and the bath operating lifetime of the electrolyte is limited to a few days and at the end of a bath operating lifecycle, tool cleaning processes are required, which are associated with a high safety-related effort. Thus, this process is a high cost process and a very unstable process.

### SUMMARY

Various embodiments provide a method for depositing metal on a substrate. The method may include carrying out a first immersion plating process, thereby forming a first metal portion on the substrate; providing an immersion plating activating substance on the first metal portion; and carrying out a second immersion plating process using the immersion plating activating substance, thereby forming a second metal portion on the first metal portion.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a method for depositing metal on a substrate at a first process stage in accordance with an embodiment;

FIG. 2 shows a method for depositing metal on a substrate at a second process stage in accordance with an embodiment;

FIG. 3 shows a method for depositing metal on a substrate at a third process stage in accordance with an embodiment;

FIG. 4 shows a method for depositing metal on a substrate at a fourth process stage in accordance with an embodiment;

FIG. 5 shows a method for depositing metal on a substrate at a fifth process stage in accordance with an embodiment;

FIG. 6 shows a method for depositing metal on a substrate at a sixth process stage in accordance with an embodiment;

FIG. 7 shows a method for depositing metal on a substrate at a seventh process stage in accordance with an embodiment;

FIG. 8 shows a method for depositing metal on a substrate at an eighth process stage in accordance with an embodiment;

FIG. 9 shows a method for depositing metal on a substrate at a ninth process stage in accordance with an embodiment;

FIG. 10 shows a flow diagram illustrating a method for depositing metal on a substrate in accordance with an embodiment;

FIG. 11 shows an auger diagram (depth profile) of a metal structure, wherein Au has been deposited on a palladium substrate in accordance with a conventional immersion plating process; and

FIG. 12 shows an auger diagram (depth profile) of a metal structure, wherein Au has been deposited on a palladium substrate in accordance with an embodiment.

### DETAILED DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Various embodiments provide a metal-activated immersion process with which it is possible to deposit metal layers of a high thickness. Illustratively, in various embodiments, an iterative process is provided, wherein each iteration includes a stopping of a partial immersion plating process in which a metal is deposited, depositing an immersion plating activating substance on the previously deposited metal, and carrying out a new partial immersion plating process using the previously deposited immersion plating activating substance as the driving force of the metal deposition. Since the process may include an arbitrary number of iterations, it is in various embodiments now possible to provide a metal layer of a (in general arbitrary) high thickness using an immersion plating process, which is as such a self-limiting process.

Various embodiments provide another electroless/chemical plating process. In various embodiments, this is an electroless plating process using a metal-activated immersion process.

The driving force of this process is an activation (which is external to the actual plating process) of the substrate using a metal or other reducing agents, including a subsequent immersion plating process.

Various advantages as well as the functionality of the process in accordance with various embodiments will be described in more detail below with specific reference to an implementation of a gold (Au) plating process. However, it is to be noted that any other suitable metal may be deposited using the processes in accordance with various embodiments, such as e.g. platinum (Pt), silver (Ag), copper (Cu), palladium (Pd), and the like.

Various embodiments make it possible to deposit a metal (e.g. Au) having an arbitrary (layer) thickness using an immersion plating process.

In various embodiments, an electroless/chemical immersion plating process is provided for depositing a metal on a substrate, e.g. for refining a surface (of the substrate) or for depositing the metal for later processing, e.g. for bonding (e.g. wire bonding, wedge bonding, and the like) a structure on the upper (released) surface of the deposited metal. As an alternative application, various embodiments may be provided in electroless plating a polymer substrate. As will be described in more detail below, an immersion plating process is provided in various embodiments. In an immersion plating process, a metal (e.g. Au), e.g. a metal layer (e.g. an Au layer), is deposited on the respective substrate by means of immersing the substrate into an electrolyte, in which the metal (e.g. Au) is soluted, e.g. in the form of cyanidic or sulfidic complexes. The driving force in this process and reaction is the electrochemical self-potential (electrochemical series). This immersion plating process has in general the advantage of a simple process control, high process stability and the high lifetime/stability/operating lifetime of the electrolyte. A conventional immersion plating process, however, is as such a self-limiting process.

As already mentioned, the driving force of the reaction is the difference of the electrochemical potentials between electrolyte and substrate. Therefore the deposition reaction runs until the substrate is fully and enclosed covered by the deposited metal layer and thus the self limiting immersion process stops regarding the lost of the electrochemical driving force. Therefore, only layers having a layer thickness in a low nanometer region (e.g. in the range from about 1 nm to about 30 nm) can be produced with a conventional immersion plating process. These small layer thicknesses, however, are too small for various applications such as for providing stable bond contacting processes or stable soldering contacting processes, in which various embodiments may be used.

As will be described in more detail below, various embodiments enable the deposition of metal having a high metal (e.g. Au) layer thickness in a activated (e.g. metal activated) step-wise immersion plating process. In these embodiments, no reducing agent is required in the metal (e.g. Au) containing electrolyte. An advantage that is provided in various embodiments is that thick metal (e.g. Au) layers may be deposited similar to the layer thicknesses which can be achieved using an electroless autocatalytic plating process while providing a process stability/electrolyte stability/bath lifetime/bath operating lifetime which is similar to an immersion plating process. Thus, various embodiments combine a simple process control, long bath operating lifetime and high layer thicknesses and achieve a process control at substantially reduced costs.

As will also be described in more detail below, in various embodiments, the entire plating process may be divided in a plurality (e.g. two) separate partial processes, which may be repeated as often as desired, namely e.g. the following two partial processes:

a first partial process, in which an immersion plating process activating substance (e.g. an immersion plating process activating metal layer) is deposited, wherein the immersion plating process activating substance is configured such that the surface of the material, the immersion plating process activating substance is deposited on, is activated for a subsequent immersion plating process; and

an immersion plating process that is activated by the immersion plating process activating substance previously deposited, wherein the metal to be deposited (e.g. Au), which is contained in an electrolyte, is deposited and the immersion plating process activating substance is removed, e.g. in a so-called exchange reaction.

Thus, illustratively, the respective substrate (possibly already including one or more metal portions or one or more metal layers) is activated in one partial process and in another partial process, a metal portion or metal layer may be deposited by means of an immersion plating process.

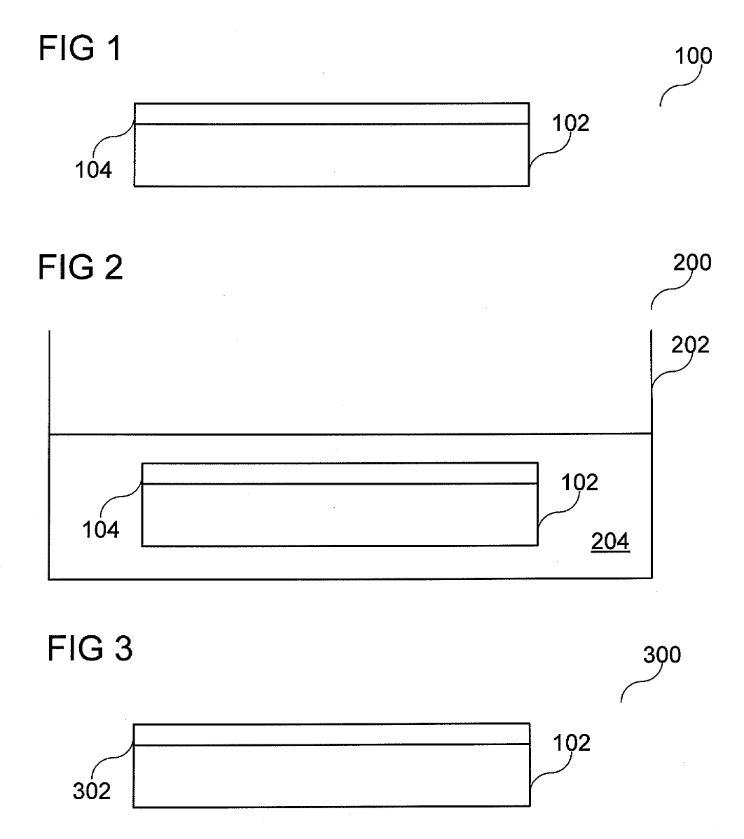

FIG. 1 shows a method for depositing metal on a substrate at a first process stage in accordance with an embodiment in a first structure 100.

As shown in FIG. 1, a substrate 102 may be provided. In various embodiments, a “substrate” 102 may be understood as being any material onto which metal should be deposited in accordance with a process of various embodiments. In various embodiments, a “substrate” 102 may include or may be made of a dielectric material and/or a semiconductor material and/or an electrically conductive material and/or a polymer. In various embodiments, a “substrate” 102 may include or may be made of a wafer or a portion of a wafer or a die or a portion of a die. In various embodiments, a “substrate” 102 may include or may be a contacting structure of a wafer or a die, e.g. a contacting pad, which may be subject to a bonding process (e.g. wire bonding, wedge bonding, and the like) and/or a soldering process, e.g. in a back-end-of-line process. In various embodiments, a “substrate” 102 may include or may be a die package or a portion of a die package to be electrically contacted via the metal to be deposited on the substrate, e.g. a bonding structure (e.g. a bond wire or a wedge bond contact) or a soldering structure. In various embodiments, a “substrate” 102 may include or may be made of any material, the surface of which is to be refined.

In an optional process, as also shown in FIG. 1, an immersion plating activating substance 104 may be provided (e.g. deposited) on the substrate 102. In various embodiments, the immersion plating activating substance 104 may be provided in various phases, such as e.g. in a gas phase, in a liquid phase or in a solid state phase. In various embodiments, the immersion plating activating substance 104 may include one or more materials, which is/are (with respect to the metal to be deposited in a subsequent immersion plating process) configured such that the surface of the substrate 102 the immersion plating process activating substance 104 is deposited on, is activated for a subsequent first immersion plating partial process. In various embodiments, the immersion plating activating substance 104 may have a lower chemical potential than the metal to be deposited by means of the first immersion plating partial process, i.e. the metal of a first metal portion or a first metal layer to be formed, as will be described in more detail below.

In various embodiments, the immersion plating activating substance 104 may be a gas (e.g. a gas having a low degree of nobility such as e.g. H₂) which might be provided in pores which may be present in the substrate 102.

In various embodiments, the immersion plating activating substance 104 may be a liquid, including a reducing agent e.g. such as Hypophosphite, formic acid, borane derivates and the like.

In various embodiments, the immersion plating activating substance 104 may be a solid state material, e.g. including a substance such as Ag; Al; Co; Cu; Fe; Mn; Mo; Ni; Ni(X)P alloys, wherein X is a metal; Pd; Pt; Rh; Ru; Zn; and an alloy including one or more of the above substances or other solid state materials with reducing properties. In various embodiments, the immersion plating activating substance 104 may be deposited as an immersion plating activating substance layer 104. The immersion plating activating substance layer 104 may have a layer thickness in the range from about 1 nm to about 100 nm, e.g. a layer thickness in the range from about 5 nm to about 40 nm, e.g. a layer thickness in the range from about 10 nm to about 30 nm. However, in various embodiments, the immersion plating activating substance layer 104 may have a different layer thickness than described above, if desired. In various embodiments, the immersion plating activating substance layer 104 may have such a layer thickness that the entire immersion plating activating substance 104 or only a part of the immersion plating activating substance 104 is removed (e.g. exchanged) in the following first immersion plating partial process.

In various embodiments, the immersion plating activating substance 104 may be deposited by means of various processes, e.g. by means of a chemical vapor deposition process (CVD), a physical vapor deposition process (PVD); a galvanic metal deposition process; and/or a chemical electroless metal deposition process.

As mentioned above, the provision of the immersion plating activating substance 104 is optional, e.g. in case the surface of the substrate 102 is already activated or configured such that an immersion plating process may be carried out directly on the surface of the substrate 102.

FIG. 2 shows a method for depositing metal on a substrate at a second process stage in accordance with an embodiment in a first block diagram 200.

As shown in FIG. 2, a bath container 202 is provided, which may be partially filled with an electrolyte 204. In various embodiments, the electrolyte 204 may include the metal to be deposited on the substrate 102 (with or without the immersion plating activating substance 104) in an immersion plating process. In various embodiments, the electrolyte 204 may include the metal to be deposited in various forms, e.g. in a complex, e.g. in a cyanidic or sulfidic complex.

In various embodiments, the metal to be deposited on the substrate 102 (with or without the immersion plating activating substance 104), i.e. e.g. the metal which should form the first metal portion or first metal layer, may include or consist of Au; Ag; Cu; Pt; and/or Pd. In various embodiments, the material pair of immersion plating activating substance 104 (or the surface material of the substrate 102) and the metal to be deposited are selected such that the immersion plating activating substance 104 (or the surface material of the substrate 102) has a lower degree of nobility than the metal to be deposited so that a first immersion plating partial process may be carried out when the structure 100 is immersed into the electrolyte 204, as shown in FIG. 2.

In various embodiments, in the first immersion plating partial process which is carried out in the electrolyte 204, an exchange reaction may take place during which the immersion plating activating substance 104 (or the surface material of the substrate 102) may be (fully or partially) be replaced by the metal in the electrolyte 204 due to the difference of the electrochemical (self-)potentials between the immersion plating activating substance 104 (or the surface material of the substrate 102) and the metal in the electrolyte 204. Thus, a first metal portion 302 or a first metal layer 302 may be deposited by means of the first immersion plating partial process, as shown in FIG. 3 in a second structure 300.

In various embodiments, the first immersion plating partial process may be stopped by a process control automatically or manually (e.g. after a predefined process time) or it may be stopped due to the above-described self-limitation of an immersion plating process. It should be mentioned that depending on whether the entire immersion plating activating substance 104 has been replaced by the metal in the first immersion plating partial process or not, there may still be some rests of the immersion plating activating substance 104 in the second structure 300, which is, however, not shown in FIG. 3 for reasons of clarity.

In various embodiments, the first metal portion 302 or first metal layer 302 may have a layer thickness in the range from about 1 nm to about 30 nm, e.g. in the range from about 5 nm to about 25 nm, e.g. in the range from about 10 nm to about 20 nm.

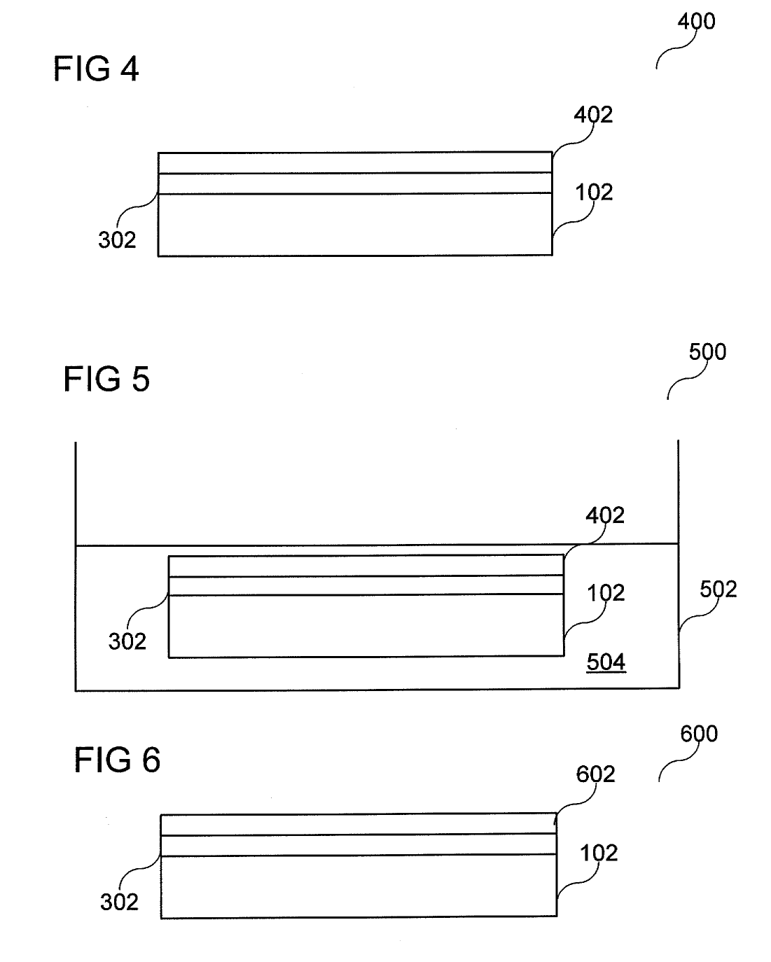

FIG. 4 shows a method for depositing metal on a substrate at a fourth process stage in accordance with an embodiment in a third structure 400.

As shown in FIG. 4, after the first immersion plating partial process has been stopped (and e.g. the second structure 300 has been taken out of the electrolyte 204), another immersion plating activating substance 402 (which may be the same immersion plating activating substance as the immersion plating activating substance 104 or a different immersion plating activating substance than the immersion plating activating substance 104) may be provided (e.g. deposited) on the first metal portion 302 or first metal layer 302.

In various embodiments, the immersion plating activating substance 402 may be provided in various phases, such as e.g. in a gas phase, in a liquid phase or in a solid state phase. In various embodiments, the immersion plating activating substance 402 may include one or more materials, which is/are (with respect to the metal to be deposited in a subsequent immersion plating process) configured such that the surface of the first metal portion 302 or first metal layer 302 the immersion plating process activating substance 402 is deposited on, is activated for a subsequent second immersion plating partial process. In various embodiments, the immersion plating activating substance 402 may have a lower chemical potential than the metal to be deposited, i.e. the metal of a second metal portion or a second metal layer to be formed, as will be described in more detail below.

In various embodiments, the immersion plating activating substance 402 may be a gas (e.g. a gas having a low degree of nobility such as e.g. H₂) which might be provided in pores which may be present in the first metal portion 302 or first metal layer 302.

In various embodiments, the immersion plating activating substance 402 may be a liquid, including a reducing agent e.g. such as Hypophosphite, formic acid, borane derivates and the like.

In various embodiments, the immersion plating activating substance 402 may be a solid state material, e.g. including a substance such as Ag; Al; Co; Cu; Fe; Mn; Mo; Ni; Ni(X)P alloys, wherein X is a metal; Pd; Pt; Rh; Ru; Zn; and an alloy including one or more of the above substances or other solid state materials with reducing properties. In various embodiments, the immersion plating activating substance 402 may be deposited as an immersion plating activating substance layer 402. The immersion plating activating substance layer 402 may have a layer thickness in the range from about 1 nm to about 100 nm, e.g. a layer thickness in the range from about 5 nm to about 40 nm, e.g. a layer thickness in the range from about 10 nm to about 30 nm. However, in various embodiments, the immersion plating activating substance layer 402 may have a different layer thickness than described above, if desired. In various embodiments, the immersion plating activating substance layer 402 may have such a layer thickness that the entire immersion plating activating substance 402 or only a part of the immersion plating activating substance 402 is removed (e.g. exchanged) in the following immersion plating partial process.

In various embodiments, the immersion plating activating substance 402 may be deposited by means of various processes, e.g. by means of a chemical vapor deposition process (CVD), a physical vapor deposition process (PVD); a galvanic metal deposition process; and/or a chemical electroless metal deposition process.

FIG. 5 shows a method for depositing metal on a substrate at a fifth process stage in accordance with an embodiment in a second block diagram 500.

As shown in FIG. 5, a bath container 502 (which may be the same bath container as the bath container 202 as shown in FIG. 2, or a different bath container) may be provided, which may be partially filled with an electrolyte 504 (which may be the same electrolyte as the electrolyte 204 as shown in FIG. 2, or a different electrolyte). In various embodiments, the electrolyte 504 may include the metal to be deposited on the first metal portion 302 or first metal layer 302 in an immersion plating process. In various embodiments, the electrolyte 504 may include the metal to be deposited in various forms, e.g. in a complex, e.g. in a cyanidic or sulfidic complex.

In various embodiments, the metal to be deposited on the first metal portion 302 or first metal layer 302, i.e. e.g. the metal which should form the second metal portion or second metal layer, may include or consist of Au; Ag; Cu; Pt; and/or Pd. In various embodiments, the pair of the immersion plating activating substance 402 and the metal to be deposited are selected such that the immersion plating activating substance 402 has a lower degree of nobility than the metal to be deposited so that a second immersion plating partial process may be carried out when the structure 400 is immersed into the electrolyte 504, as shown in FIG. 5.

In various embodiments, in the second immersion plating partial process which is carried out in the electrolyte 504, an exchange reaction may take place during which the immersion plating activating substance 402 may be (fully or partially) be replaced by the metal in the electrolyte 504 due to the difference of the electrochemical (self-)potentials between the immersion plating activating substance 402 and the metal in the electrolyte 504. Thus, a second metal portion 602 or a second metal layer 602 may be deposited by means of the second immersion plating partial process, as shown in FIG. 6 in a fourth structure 600. In various embodiments, the second immersion plating partial process may be stopped by a process control automatically or manually (e.g. after a predefined process time) or it may be stopped due to the above-described self-limitation of an immersion plating process. It should be mentioned that depending on whether the entire immersion plating activating substance 402 has been replaced by the metal in the second immersion plating partial process or not, there may still be some rests of the immersion plating activating substance 402 in the fourth structure 600, which is, however, not shown in FIG. 6 for reasons of clarity.

In various embodiments, the second metal portion 602 or second metal layer 602 may have a layer thickness in the range from about 1 nm to about 30 nm, e.g. in the range from about 5 nm to about 25 nm, e.g. in the range from about 10 nm to about 20 nm.

In various embodiments, the metal of the second metal portion 602 or second metal layer 602 may be the same metal as the metal of the first metal portion 302 or first metal layer 302. However, in alternative embodiments, the metals may be different from each other.

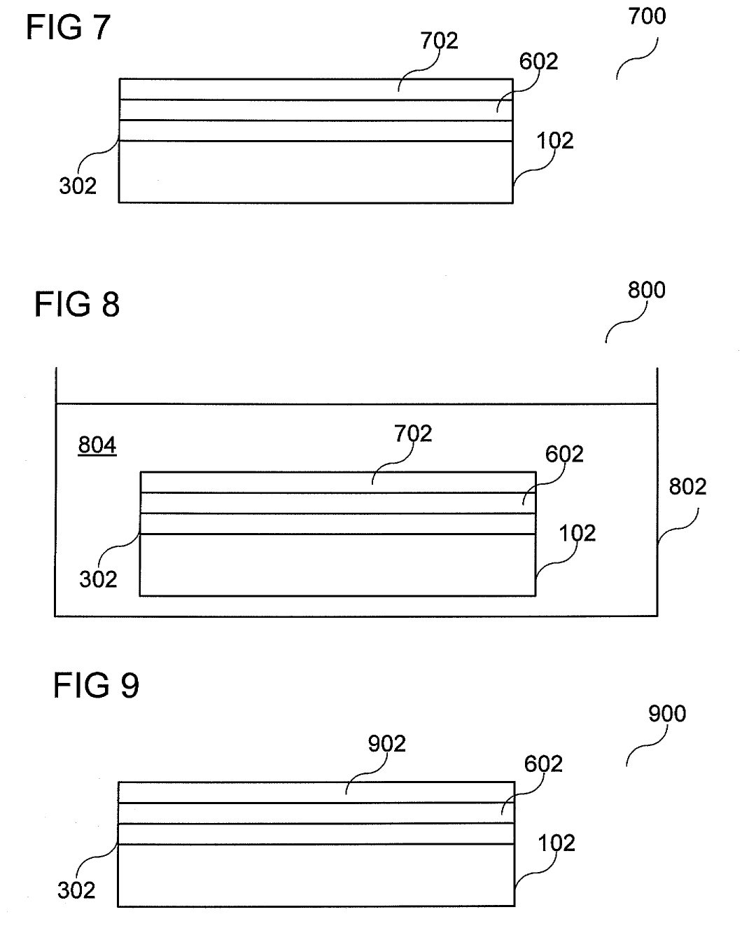

FIG. 7 shows a method for depositing metal on a substrate at a seventh process stage in accordance with an embodiment in a fifth structure 700.

As shown in FIG. 7, after the second immersion plating partial process has been stopped (and e.g. the fourth structure 600 has been taken out of the electrolyte 504), another immersion plating activating substance 702 (which may be the same immersion plating activating substance as the immersion plating activating substance 104 and/or the immersion plating activating substance 402, or a different immersion plating activating substance than the immersion plating activating substance 104 and/or the immersion plating activating substance 402) may be provided (e.g. deposited) on the second metal portion 602 or second metal layer 602.

In various embodiments, the immersion plating activating substance 702 may be provided in various phases, such as e.g. in a gas phase, in a liquid phase or in a solid state phase. In various embodiments, the immersion plating activating substance 702 may include one or more materials, which is/are (with respect to the metal to be deposited in a subsequent immersion plating process) configured such that the surface of the second metal portion 602 or second metal layer 602 the immersion plating process activating substance 702 is deposited on, is activated for a subsequent second immersion plating partial process. In various embodiments, the immersion plating activating substance 702 may have a lower chemical potential than the metal to be deposited, i.e. the metal of a third metal portion or a third metal layer to be formed, as will be described in more detail below.

In various embodiments, the immersion plating activating substance 702 may be a gas (e.g. a gas having a low degree of nobility such as e.g. H₂) which might be provided in pores which may be present in the second metal portion 602 or second metal layer 602.

In various embodiments, the immersion plating activating substance 702 may be a liquid, including a reducing agent e.g. such as Hypophosphite, formic acid, borane derivates and the like.

In various embodiments, the immersion plating activating substance 702 may be a solid state material, e.g. including a substance such as Ag; Al; Co; Cu; Fe; Mn; Mo; Ni; Ni(X)P alloys, wherein X is a metal; Pd; Pt; Rh; Ru; Zn; and an alloy including one or more of the above substances or other solid state materials with reducing properties. In various embodiments, the immersion plating activating substance 702 may be deposited as an immersion plating activating substance layer 702. The immersion plating activating substance layer 702 may have a layer thickness in the range from about 1 nm to about 100 nm, e.g. a layer thickness in the range from about 5 nm to about 40 nm, e.g. a layer thickness in the range from about 10 nm to about 30 nm. However, in various embodiments, the immersion plating activating substance layer 702 may have a different layer thickness than described above, if desired. In various embodiments, the immersion plating activating substance layer 702 may have such a layer thickness that the entire immersion plating activating substance 702 or only a part of the immersion plating activating substance 702 is removed (e.g. exchanged) in the following immersion plating partial process.

In various embodiments, the immersion plating activating substance 702 may be deposited by means of various processes, e.g. by means of a chemical vapor deposition process (CVD), a physical vapor deposition process (PVD); a galvanic metal deposition process; and/or a chemical electroless metal deposition process.

FIG. 8 shows a method for depositing metal on a substrate at an eighth process stage in accordance with an embodiment in a third block diagram 800.

As shown in FIG. 8, a bath container 802 (which may be the same bath container as the bath container 202 as shown in FIG. 2 and/or as the bath container 502 as shown in FIG. 5, or a different bath container) may be provided, which may be partially filled with an electrolyte 804 (which may be the same electrolyte as the electrolyte 204 as shown in FIG. 2 and/or as the electrolyte 504 as shown in FIG. 5, or a different electrolyte). In various embodiments, the electrolyte 804 may include the metal to be deposited on the second metal portion 602 or second metal layer 602 in an immersion plating process. In various embodiments, the electrolyte 804 may include the metal to be deposited in various forms, e.g. in a complex, e.g. in a cyanidic or sulfidic complex.

In various embodiments, the metal to be deposited on the second metal portion 602 or second metal layer 602, i.e. e.g. the metal which should form the third metal portion or third metal layer, may include or consist of Au; Ag; Cu; Pt; and/or Pd. In various embodiments, the pair or immersion plating activating substance 702 and the metal to be deposited are selected such that the immersion plating activating substance 702 has a lower degree of nobility than the metal to be deposited so that a third immersion plating partial process may be carried out when the structure 700 is immersed into the electrolyte 804, as shown in FIG. 8.

In various embodiments, in the third immersion plating partial process which is carried out in the electrolyte 804, an exchange reaction may take place during which the immersion plating activating substance 702 may be (fully or partially) be replaced by the metal in the electrolyte 804 due to the difference of the electrochemical (self-)potentials between the immersion plating activating substance 702 and the metal in the electrolyte 804. Thus, a third metal portion 902 or a third metal layer 902 may be deposited by means of the third immersion plating partial process, as shown in FIG. 9 in a sixth structure 900. In various embodiments, the third immersion plating partial process may be stopped by a process control automatically or manually (e.g. after a predefined process time) or it may be stopped due to the above-described self-limitation of an immersion plating process. It should be mentioned that depending on whether the entire immersion plating activating substance 702 has been replaced by the metal in the third immersion plating partial process or not, there may still be some rests of the immersion plating activating substance 702 in the sixth structure 900, which is, however, not shown in FIG. 9 for reasons of clarity.

In various embodiments, the third metal portion 902 or third metal layer 902 may have a layer thickness in the range from about 1 nm to about 30 nm, e.g. in the range from about 5 nm to about 25 nm, e.g. in the range from about 10 nm to about 20 nm.

In various embodiments, the metal of the third metal portion 902 or third metal layer 902 may be the same metal as the metal of the first metal portion 302 or first metal layer 302 and/or the metal of the second metal portion 602 or second metal layer 602. However, in alternative embodiments, the metals may be different from each other.

It should be mentioned that in various embodiments, an arbitrary number of iterations or repetitions of the provision of the immersion plating activating substance and the respective immersion plating partial process may be provided, e.g. one iteration (resulting e.g. in a structure as the fourth structure 600 as shown in FIG. 6), two iterations (resulting e.g. in a structure as the sixth structure 900 as shown in FIG. 9), three iterations, four iterations, or even more iterations. Thus, in general, a metal of arbitrary layer thickness may be deposited on the substrate using the technology of an immersion plating process.

Thus, in various embodiments, a metal structure, e.g. a wafer or a die including one or more contacting pads as an implementation of the metal structure is provided. The metal structure (e.g. the fourth structure 600 or the sixth structure 900) may include a substrate 102, an immersion plated first metal portion 302 or immersion plated first metal layer 302 disposed on or above the substrate 102, an immersion plated second metal portion 602 or immersion plated second metal layer 602 on the first metal portion 302 or first metal layer 302, and an immersion plating activating substance (not shown in FIG. 6) between the first metal portion 302 or first metal layer 302 and the second metal portion 602 or second metal layer 602. In various embodiments, an immersion plating activating substance (not shown in FIG. 6) may be provided between the substrate 102 and the first metal portion 302 or first metal layer 302.

In various embodiments, the metal structure (e.g. the sixth structure 900) may further include an immersion plated third metal portion 902 or immersion plated third metal layer 902 on the second metal portion 602 or second metal layer 602, and an immersion plating activating substance (not shown in FIG. 9) between the second metal portion 602 or second metal layer 602 and the third metal portion 902 or third metal layer 902.

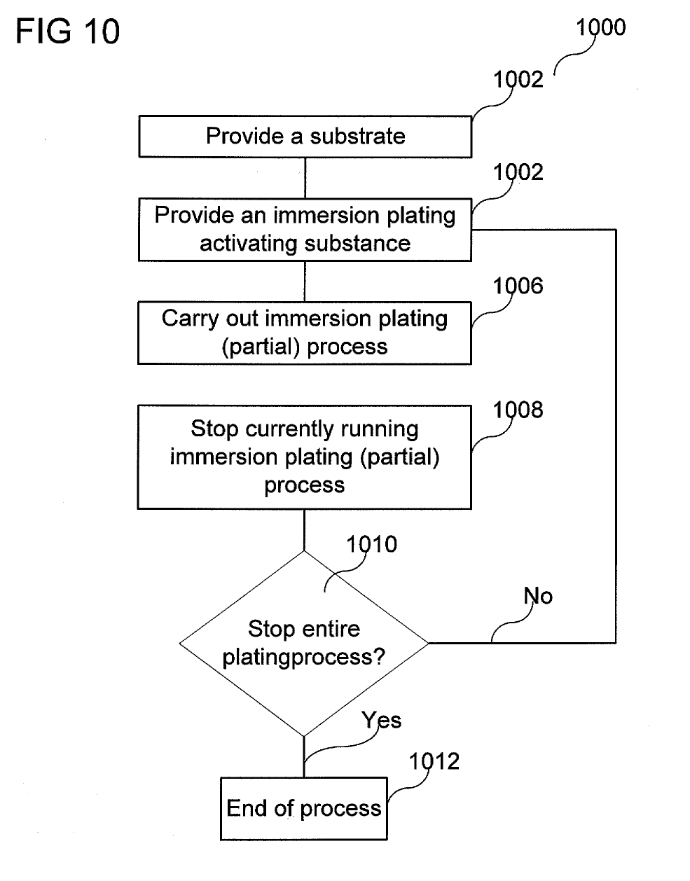

FIG. 10 shows a flow diagram 1000 illustrating a method for depositing metal on a substrate in accordance with an embodiment. As shown in FIG. 10, the method may include, in 1002, providing a substrate, and, in 1004, providing an immersion plating activating substance (such as one as described above) on the substrate. Furthermore, in 1006, an immersion plating partial process (e.g. a first immersion plating partial process, a second immersion plating partial process, a third immersion plating partial process, . . . , an n-th immersion plating partial process, wherein n denotes the number of immersion plating partial processes to be carried out in the method) may be carried out. In 1008, the respective immersion plating partial process may be stopped (e.g. the substrate may be taken out of the electrolyte providing for the immersion plating partial process) and it may be determined in 1010 as to whether the entire method of depositing metal should be stopped or not; in other words, it is determined as to whether another metal portion or metal layer should be deposited or as to whether the desired number of metal portions or metal layers have been deposited (in other words as to whether the desired total layer thickness of the metal to be deposited has been reached). In case it is determined in 1010 that an additional metal portion or metal layer should be deposited (in other words, an additional iteration should be carried out) (“No” in 1010), then the method continues in 1002 for depositing another metal portion or metal layer by carrying out processes 1002, 1006, 1008, again. In case it is determined in 1010 that no additional metal portion or metal layer should be deposited (in other words, the entire plating process should be stopped) (“Yes” in 1010), then the method ends in 1012.

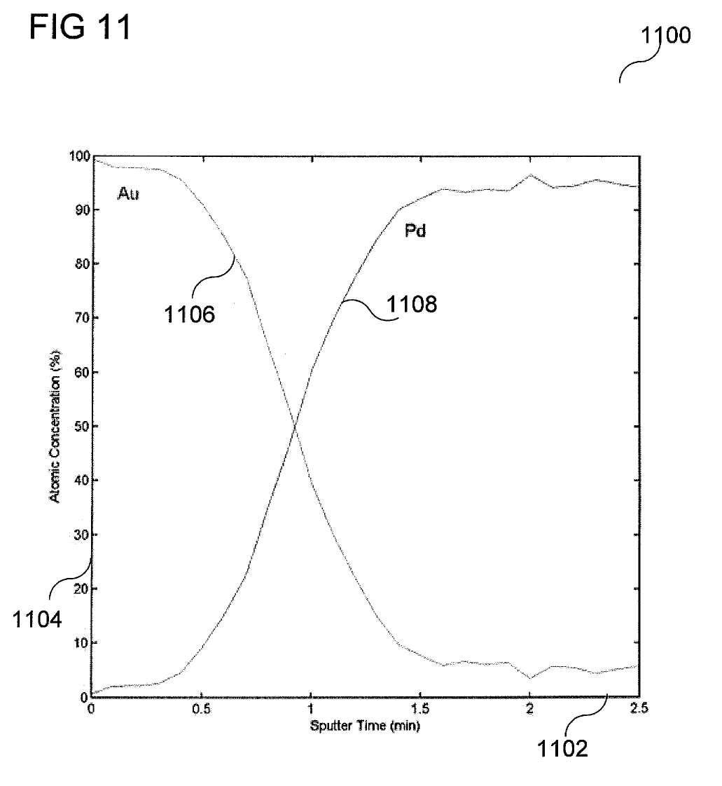

In contrast to the conventional deposition of metal stacks (e.g. in the context of a conventional pad enforcement), in various embodiments, by selecting the process parameters in a suitable manner such as e.g. layer thickness of the activating substance, the surface distribution of the activating substance on the substrate, the surface concentration of the activating substance on the substrate, surface roughness, temperature and the like, for the deposition of the activating metal layer as well as for the (e.g. Au) immersion plating process, not a layer sequence of different metals is obtained, but a homogeneous and smooth metal (e.g. Au) layer may be obtained which are not separated by individual layer interfaces, but only minor traces of the activating metal (in general activating substance) may be found. This may result in an avoidance of layer delamination, reduced mechanical stability (e.g. shear resistance), additive transition resistances, changed high frequency behaviour or other disturbances. The physical and structural layer integrity is in itself continuous and does not show any, or at least less than in a conventional structure, step behaviour, as shown in FIG. 11, which will be described in more detail below. Thus, various embodiments are particularly suitable for manufacturing bonding contacts or soldering contacts of high frequency circuit back-end-of-line packages. Furthermore, various embodiments are provided for manufacturing bonding contacts or soldering contacts for back-end-of-line packages of logic circuits, memory circuits, mixed signal circuits, single semiconductor devices, and the like.

FIG. 11 shows an auger diagram 1100 (depth profile) of a metal structure, wherein Au has been deposited on a palladium substrate in accordance with a conventional immersion plating process. The auger diagram 1100 has an abscissa 1102 representing the sputtering time (in minutes), and an ordinate 1104 representing the atomic concentration (in %) of a respectively detected material. In FIG. 11, two characteristics 1106, 1108 are shown, namely a first characteristic 1106 representing the atomic concentration (in %) of detected gold (Au), and a second characteristic 1108 representing the atomic concentration (in %) of detected palladium (Pd). As shown in FIG. 11, there is an interface between the Au layer and the Pd material, and, since the etching rate in this case was approximately 10 nm to 15 nm per minute, and since after about 1.5 minutes, substantially no Au was detected any more, the Au layer in this case had a layer thickness of about 15 nm to 22.5 nm.

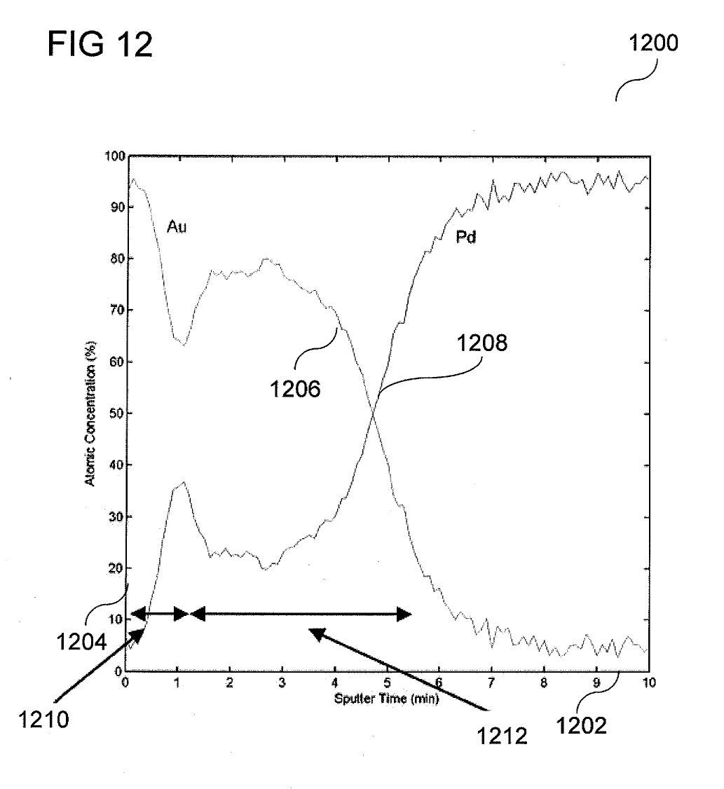

FIG. 12 shows an auger diagram 1200 (depth profile) of a metal structure, wherein Au has been deposited on a palladium substrate in accordance with an embodiment. The auger diagram 1200 has an abscissa 1202 representing the sputtering time (in minutes), and an ordinate 1204 representing the atomic concentration (in %) of a respectively detected material. In FIG. 12, two characteristics 1206, 1208 are shown, namely a first characteristic 1206 representing the atomic concentration (in %) of detected gold (Au), and a second characteristic 1208 representing the atomic concentration (in %) of detected palladium (Pd). As shown in FIG. 12, there are shown two regions 1210 and 1212 illustrating the effects of the method in accordance with various embodiments. The first region 1210, which includes the beginning of the sputterin process, approximately the first 1.25 minutes, the characteristics 1206, 1208 are rather similar to the characteristics 1106, 1108 as shown in FIG. 11. Then, in the second region 1212, which represents the subsequent sputtering time until approximately 5.25 minutes of sputtering, the still high atomic concentration of Au in the first characteristic 1206 illustrates the additive layer increase due to the metal-activated immersion plating process including an iteration of a plurality of immersion plating partial processes in accordance with various embodiments. The first characteristic 1206 illustrates a layer thickness of the Au layer of approximately 60 nm to 100 nm, since the etching rate in this case also was approximately 10 nm to 15 nm per minute. This shows the increased layer thickness of the Au layer which is made possible by the methods in accordance with various embodiments. Furthermore, the first characteristic 1206 in FIG. 12 also shows that there are no abrupt interfaces between the metal layers deposited in the respective iterations, since during the deposition, in various embodiments, a self-anneal may be provided which results in a crystallization of the respective metal layers in the layer stack including the plurality of metal layers deposited in the plurality of immersion plating iterations. The anneal process may in various embodiments also be thermally activated.

Various embodiments provide an improved bondpad refinement including very high metal (e.g. Au) layer thicknesses, thereby achieving a higher process stability at a later bonding process.

The increase of the metal (e.g. Au) layer thickness may result in an improved bond adhesion and thus stable bond shear values. Furthermore, the subsequent bonding process may be simplified or made less costly, since it is now possible to dispense with cleaning processes (e.g. Ar plasma cleaning process for removing surface oxides) before the bonding process and nevertheless to achieve well adhesive bonds and high shear values.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for depositing metal on a substrate, the method comprising:
carrying out a first immersion plating process, thereby forming a first metal portion on the substrate;
providing an immersion plating activating substance on the first metal portion;
carrying out a second immersion plating process using the immersion plating activating substance, thereby forming a second metal portion on the first metal portion.

2. The method of claim 1, further comprising:
providing an immersion plating activating substance on the substrate before the first immersion plating process is carried out.

3. The method of claim 1,
wherein the first metal portion and the second metal portion comprise the same metal.

4. The method of claim 1,
wherein the immersion plating activating substance has a lower chemical potential than the metal of at least one of the first metal portion and the second metal portion.

5. The method of claim 4,
wherein the immersion plating activating substance comprises a substance selected from a group consisting of: Ag; Al; Co; Cu; Fe; Mn; Mo; Ni; Ni(X)P alloys, wherein X is a metal; Pd; Pt; Rh; Ru; Zn; and an alloy comprising one or more of the above substances.

6. The method of claim 1,
wherein the metal of at least one of the first metal portion and the second metal portion comprises a metal selected from a group of metals consisting of: Au; Ag; Cu; Pt; and Pd.

7. The method of claim 1, further comprising:
providing an immersion plating activating substance on the second metal portion;
carrying out a third immersion plating process using the immersion plating activating substance, thereby forming a third metal portion on the second metal portion.

8. The method of claim 1,
wherein the immersion plating activating substance is deposited as a layer having a layer thickness in the range from about 1 nm to about 100 nm.

9. The method of claim 1,
wherein at least one of the first metal portion and the second metal portion is formed as a layer having a layer thickness in the range from about 1 nm to about 30 nm.

10. A metal structure, comprising:
a substrate;
an immersion plated first metal portion above the substrate;
an immersion plated second metal portion on the first metal portion; and
an immersion plating activating substance between the first metal portion and the second metal portion.

11. The metal structure of claim 10,
wherein the first metal portion and the second metal portion comprise the same metal.

12. The metal structure of claim 10,
wherein the immersion plating activating substance has a lower chemical potential than the metal of at least one of the first metal portion and the second metal portion.

13. The metal structure of claim 12,
wherein the immersion plating activating substance comprises a substance selected from a group consisting of: Ag; Al; Co; Cu; Fe; Mn; Mo; Ni; Ni(X)P alloys, wherein X is a metal; Pd; Pt; Rh; Ru; Zn; and an alloy comprising one or more of the above substances.

14. The metal structure of claim 10,
wherein the metal of at least one of the first metal portion and the second metal portion comprises a metal selected from a group of metals consisting of: Au; Ag; Cu; Pt; and Pd.

15. The metal structure of claim 10, further comprising:
an immersion plated third metal portion on the second metal portion; and
an immersion plating activating substance between the second metal portion and the third metal portion.

16. The metal structure of claim 10,
wherein at least one of the first metal portion and the second metal portion is a layer having a layer thickness in the range from about 1 nm to about 30 nm.

17. A method for plating a metal on a substrate, the method comprising:
carrying out a first immersion plating partial process to form a first metal layer on the substrate;
providing an immersion plating activator on the first metal layer;
carrying out a second immersion plating partial process to form a second metal layer on the first metal layer, wherein the immersion plating activator acts as an activator for the second immersion plating partial process.

18. The method of claim 17, further comprising:
providing a further immersion plating activator on the substrate before the first immersion plating partial process is carried out.

19. The method of claim 17,
wherein the first metal layer and the second metal layer comprise the same metal.

20. The method of claim 17,
wherein the immersion plating activator has a lower chemical potential than the metal of at least one of the first metal layer and the second metal layer.

21. The method of claim 20,
wherein the immersion plating activator comprises a substance selected from a group consisting of: Ag; Al; Co; Cu; Fe; Mn; Mo; Ni; Ni(X)P alloys, wherein X is a metal; Pd; Pt; Rh; Ru; Zn; and an alloy comprising one or more of the above substances.

22. The method of claim 20,
wherein the metal of at least one of the first metal layer and the second metal layer comprises a metal selected from a group of metals consisting of: Au; Ag;
Cu; Pt; and Pd.

23. The method of claim 17, further comprising:
providing a further immersion plating activator on the second metal layer;
carrying out a third immersion plating partial process using the immersion plating activator, thereby forming a third metal layer on the second metal layer.

24. The method of claim 17,
wherein at least one of the first metal layer and the second metal layer has a layer thickness in the range from about 1 nm to about 30 nm.
